(19) United States
(12) Patent Application Publication
(10) Pub. No.: US 2009/0056839 A1
(43) Pub. Date: Mar. 5, 2009

(54) Method for Improving Residual Stress of Structure Member

(75) Inventors: Satoru Aoike, Tokai (JP); Fuminori Iwamatsu, Hitachi (JP); Yuka Fukuda, Hitachi (JP); Osamu Saitou, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi-GE Nuclear Energy, Ltd.

(21) Appl. No.: 12/193,791

(22) Filed: Aug. 19, 2008

(30) Foreign Application Priority Data
Aug. 29, 2007 (JP) 2007-221987

(51) Int. Cl. C21D 9/08; F16L 55/10

(52) U.S. Cl. 148/519; 138/89

(57) ABSTRACT

A method for improving residual stress of a structure member, comprising steps of:

disposing coolant vessels around a pipe being the structure member at an upstream position and a downstream position of a welded portion of the pipe;

wrapping a heat insulation member around an outer periphery of the pipe at a center portion in an axial direction of the pipe in each of the coolant vessels;

forming the ice plug in the pipe at each position disposing the coolant vessels by cooling an outer surface of the pipe wrapping the heat insulation member in the coolant vessels; and

freezing water between the ice plugs in the pipe by cooling the outer surface of the pipe between the ice plugs.

### CLAIM OF PRIORITY

The present application claims priority from Japanese Patent application serial no. 2007-221987, filed on Aug. 29, 2007, the content of which is hereby incorporated by reference into this application.

### BACKGROUND OF THE INVENTION

The present invention relates to a method for improving residual stress of a structure member, and more particularly, to a method for improving residual stress of a structure member preferably applied to improve the progress and occurrence sensitivity of the stress corrosion cracking for a welded part of small-diameter pipes made of a nickel base alloy or austenitic stainless steel, which is likely to cause a stress corrosion crack.

Japanese Patent Laid-open No. 2006-334596 discloses an exemplary method for improving the occurrence sensitivity of the stress corrosion cracking by alleviating residual stress exerted on the inner surface of a welded part of a pipe. This method improves the residual stress by cooling the outer surface of a pipe to expand the pipe.

In the example in Japanese Patent Laid-open No. 2006-334596, coolant vessels used for forming ice plug are disposed upstream and downstream of a butt-welding portion. The outer surface of the pipe is cooled at an upstream position and a downstream position of the butt-welding portion by the coolant vessels and ice plugs are formed in the pipe at these positions. After the ice plugs are formed, water in the pipe between the ice plugs freezes by cooling the outer surface of the pipe so that the vicinity of the welded portion of the pipe is expanded due to volume expansion at the time of freezing the water. Therefore, compression residual stress is given to the inner surface of the pipe.

Another example is disclosed in Japanese Patent Laid-open No. Sho 54(1979)-060694, in which a difference in temperature is caused between the inner surface and outer surface of a pipe to improve residual stress.

In the example of Japanese Patent Laid-open No. Sho 54(1979)-060694, the outer surface of a pipe is heated and the inner surface of the pipe is cooled so as to cause a large difference in temperature between the inner surface and outer surface of the pipe. Thermal expansion due to the temperature difference is then used to cause a compression yield on the outer surface and a tensile yield on the inner surface, giving compression residual stress to the inner surface of the pipe.

### SUMMARY OF THE INVENTION

When a nickel base alloy and austenitic stainless steel under tensile residual stress is left in hot pure water for a long period of time, the stress corrosion cracking may occur in the nickel base alloy and austenitic stainless steel.

Some pipes composing a nuclear power plant are made of a nickel base alloy or austenitic stainless steel. In the vicinity of the welded portion of these pipes, where residual stress on the inner surfaces of the pipes is tensile residual stress due to welding, to improve the occurrence sensitivity and progress of the stress corrosion cracking, it is desirable to reduce the tensile residual stress and further desirable to change the tensile residual stress to the compression residual stress.

When the above pipe is expanded by cooling its outer surface in order to improve the tensile residual stress, the pressure between ice plugs in the pipe is raised during the pipe expansion. To perform a stable expansion, the length of the ice plug in an axis direction must be elongated.

When the tensile residual stress is improved by a difference in temperature between the inner surface and outer surface of the pipe, if the diameter of the pipe is small, it is difficult to cause a difference in temperature sufficient enough to provide plastic deformation on the inner surface and outer surface of the pipe because the thickness of the pipe is small.

An object of the present invention is to provide a method for improving residual stress of a structure member that can improve resistance of an ice plug to pressure and thereby reducing size of a coolant vessel used for forming the ice plug in the method for improving residual stress in which an outer surface of a pipe is cooled to expand the pipe and a method for improving residual stress of a structure member that can improve the residual stress of the pipe, thickness of which is thin, even when a sufficient difference in temperature is hard to obtain between an inner surface and an surface of the pipe, in the method in which a temperature difference is created between the inner surface and the outer surface in order to improve the residual stress.

A feature of the present invention for attaining the above object is that in the method for improving residual stress in which an outer surface of a pipe is cooled to expand the pipe, cooling rate at a center portion in a coolant vessel during forming ice plug is reduced by insulating thermally at the center portion in the coolant vessel, and an center portion of the ice plug freezes last. Another feature of the present invention for attaining the above object is that in a method in which a difference in temperature is caused between an inner surface and outer surface of a pipe to improve residual stress, tensile load is added to the pipe in an axial direction.

Specifically describing the method of the present invention for improving residual stress in the pipe, coolant vessels for forming ice plug are disposed around the pipe at upstream and downstream positions of a butt-welding portion of the pipe; a heat insulation member is wrapped around an outer periphery of the pipe in the coolant vessel at a center portion in an axial direction of the pipe in the coolant vessel; ice plugs with resistant to pressure are formed in a pipe by cooling an outer surface of the pipe surrounded by the coolant vessel in a state that the heat insulation member is wrapped in the coolant vessel; water in the pipe between the ice plugs is frozen by further cooling the outer surface of the pipe between the ice plugs; and the pipe is expanded in a radial direction during freezing the water so that compression residual stress is generated in an inner surface of the pipe.

In a preferable method of the present invention for improving residual stress of a structure member, the coolant vessel is disposed on the pipe and surrounds the pipe so that a butt-welding portion of the pipe filled with water is positioned at the center portion in the coolant vessel; the heat insulation member is wrapped around the butt-welding portion and the entire outer peripheries of the pipes in the vicinity of the butt-welding portion; and the butt-welding portion and the vicinity of the butt-welding portion are expanded in a radial direction of the pipe by cooling the outer surface of the pipe in the coolant vessel so that compression residual stress is generated in an inner surface of the pipe.

It is preferable to wrap the heat insulation member at the center portion in the coolant vessel in an axial direction of a pipe and thereby forming the ice plug resistant to pressure within the pipe.

In a further preferable method of the present invention for improving residual stress in a pipe, the tensile load is added to the welded portion and the vicinity thereof in the axial direction of the pipe; and the welded portion and the vicinity thereof are expanded in the radial direction by increasing the pressure in the pipe so that compression residual stress is generated in the inner surface of the pipe.

In a further preferable method of the present invention for improving residual stress in pipe, the tensile load is add to the welded portion and the vicinity thereof of the pipe in the axial direction of the pipe; difference in temperature between the inner surface and outer surface of the pipe is caused by heating the outer surfaces of the welded portion and the vicinity thereof and cooling the inner surfaces of these during adding the tensile load; a tensile yield is caused by working a difference in thermal expansion resulting from the difference in temperature and tensile stress caused by the tensile load in the axial direction of the pipe so that compression residual stress is generated in the inner surface of the pipe.

In a method for adding the tensile load in the axial direction of a pipe, it is preferable to dispose two pipe-fixing devices, each of which is mounted on the pipe by clamping its outer surface, at the upstream position and downstream position of the welded portion of the pipe and to add the tensile load to the welded portion through the two pipe-fixing devices.

In the method of the present invention for improving residual stress, it is preferable to give distribution stress caused by temperature distribution or deformation to the welded portion and the vicinity thereof during adding a drawing or compressing external load in a direction in which to give residual stress, thus enabling compression residual stress to be selectively given in the direction in which the external stress has been applied.

In a method for producing the ice plug resistant to pressure within a pipe, the coolant vessel is disposed on the pipe filled with water and surrounds the pipe; the heat insulation member is wrapped around the entire outer periphery of the pipe at the center portion in the axial direction of the pipe in the coolant vessel; and the outer surface of the pipe in the coolant vessel is cooled after the coolant vessel and the heat insulation member are disposed.

According to the present invention, in the method for improving residual stress by cooling the outer surface of a pipe to expand the pipe, the resistance of an ice plug to pressure is improved because contact pressure between the ice plug and the internal surface of the pipe increases due to expansion at the center portion of the ice plug and thus frictional force on the contact surface increases. Further, according to the present invention, in the method for improving residual stress by producing a difference in temperature between the inner surface and outer surface of a pipe, the present invention can generate plastic strain in the inner surface by tensile stress superimposed by adding the tensile load in the axial direction of the pipe thereby giving the compression residual stress in the inner surface of the pipe even when the pipe is a pipe that is too thin to obtain a large temperature distribution.

### BRIEF DESCRIPTION OF THE DRAWINGS

FIG. 1 is an explanatory drawing showing a process for forming the ice plugs resistant to pressure by cooling the outer surface of a pipe that is wrapped with a heat insulation member in the entire outer periphery of the pipe at the center portion in an axial direction of the pipe in a coolant vessel.

FIG. 2 is an explanatory drawing showing a method for causing compression residual stress in the inner surface of pipe by forming ice plugs resistant to pressure within the pipes and expanding a welded portion and the vicinity thereof of the pipe due to freezing of water between the formed ice plugs.

FIG. 3 is an explanatory drawing showing a method for generating compression residual stress in the inner surface of the welded portion and the vicinity thereof of the pipe by expanding the welded portion and the vicinity thereof in a coolant vessel.

FIG. 4 is an explanatory drawing showing a coolant vessel disposed for a horizontal pipe in which a heat insulation member has been wrapped around the center portion in the coolant vessel for forming the ice plugs in the pipe.

FIG. 5 is an explanatory drawing showing a coolant vessel disposed for a vertical pipe in which a heat insulation material has been wrapped around the center portion in the coolant vessel in advance.

FIG. 6 is an explanatory drawing showing a logic that compression residual stress can be generated in the inner surface of pipe by adding an tensile load in an axial direction to the welded portion and the vicinity thereof of the pipe and expanding the welded portion and the vicinity thereof.

FIG. 7 is a method for improving residual stress of a structure member of another embodiment of the present invention using the logic shown in FIG.6.

FIG. 8 is an explanatory drawing showing a tensile apparatus for adding a tensile load to a pipe in an axial direction shown in FIG. 7.

FIG. 9 is an explanatory drawing showing a logic that compression residual stress can be generated in the inner surface of pipe by adding an tensile load in an axial direction of the pipe to the welded portion and the vicinity thereof of pipes and causing a difference in temperature between the inner surfaces and outer surfaces of the welded portion and the vicinity thereof.

FIG. 10 is a method for improving residual stress of a structure member of another embodiment of the present invention using the logic shown in FIG. 9.

FIG. 11 is an explanatory drawing showing an example in which residual stress exerted in a surface of a flat plate in the direction in which the external load is applied is improved in compression residual stress by generating temperature distribution in the flat plane and adding an external load to the flat plane.

FIG. 12 is an explanatory drawing showing a process that is conducted during working shown in FIG. 11.

FIG. 13 is an explanatory drawing showing an example in which residual stress on the surface of a solid round rod is improved in compression residual stress by heating the solid round rod to a high temperature and then steeping the solid round rod into cooling water with its axial length being restrained by a device.

### DETAILED DESCRIPTION OF THE PREFERRED EMBODIMENTS

Embodiments of the present invention will be described with reference to the drawings.

### First Embodiment

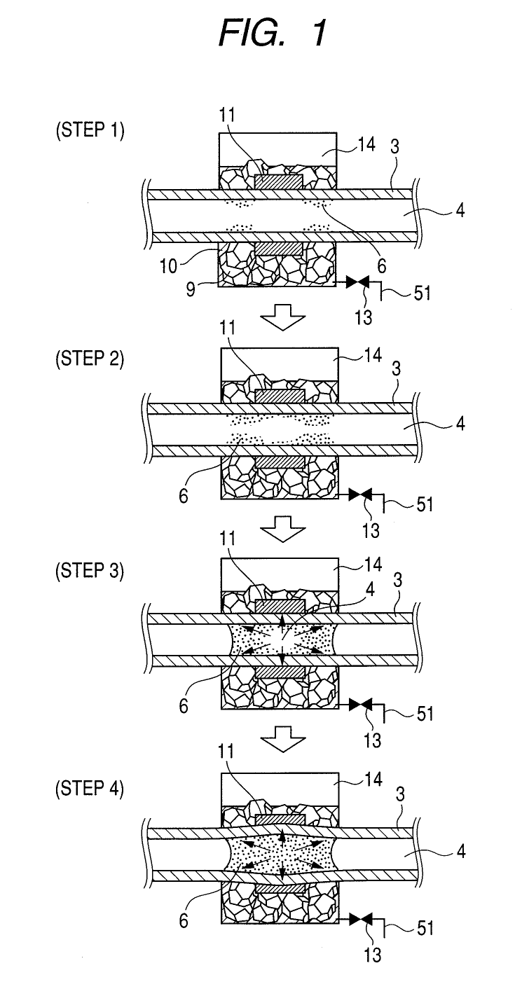

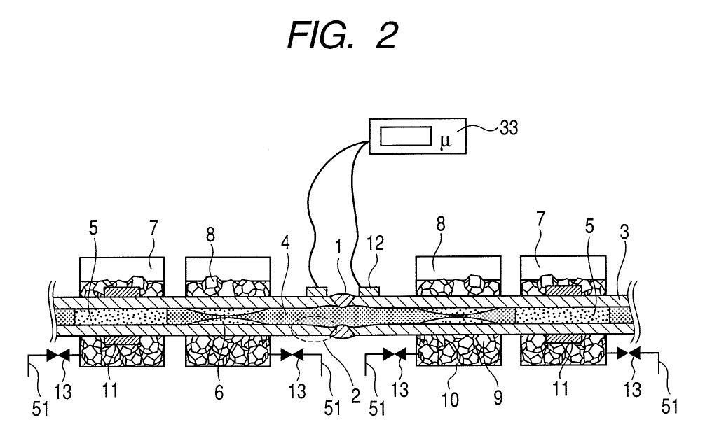

A method for improving residual stress of a structure member of an embodiment, which is one preferable embodiment of the present invention, will be described with reference to FIGS. 1 and 2. First, a method for forming an ice plug resistant to pressure within a pipe being applied to the present embodiment will be described with reference to FIG. 1. FIG. 1 shows a process for improving the resistance of the ice plug to pressure. In the method for forming the ice plug, a coolant vessel is disposed around a pipe filled with passing water, and a heat insulation material is wrapped around the entire outer periphery of the pipe in the vicinity of the center portion in the coolant vessel, and the ice plugs resistant to pressure are formed by cooling an outer surface of the pipe in the coolant vessel after the heat insulation material is wrapped.

A pipe 3 is a small-diameter pipe and thickness of the pipe 3 is thin. The small-diameter pipe is a pipe with an outer diameter of 114.3 mm or less. A coolant vessel 14 is attached to the pipe 3. A heat insulation member 11 is wrapped around an entire outer periphery of the pipe 3 in vicinity of the center portion in the coolant vessel 14 in an axial direction of the pipe before the coolant vessel 14 is attached. Ethanol 10 and dry ice 9 are then supplied to the coolant vessel 14 through an opening portion (not shown) formed at an upper end of the coolant vessel 14. In a portion being surrounded by the coolant vessel 14 (hereinafter referred to as a surrounded portion), of the pipe 3, water 4 is cooled, starting from the inner surface of the surrounded portion around which the heat insulation member 11 is not wrapped and ice 6 then starts to be formed (step 1).

As time elapses, the ice 6 also forms at a part wrapped with the heat insulation member 11, in the surrounded portion. However, the cooling capacity varies depending on whether the heat insulation member 11 is wrapped. Therefore, the water in the surrounded portion near both ends of the coolant vessel 14 freeze faster than the part wrapped with the heat insulation member 11, thus producing a difference in the thickness of the ice 6 (step 2).

As time further elapses, parts near both ends of the coolant vessel 14, at which freezing occurs faster, in the surrounded portion, are blocked by the ice 6, and the water 4 is left in the part wrapped with the heat insulation member 11, of the surrounded portion. As the freezing proceeds, the internal pressure in that part rises (step 3).

When the water 4 left in the part wrapped with the heat insulation member 11 is completely frozen, an ice plug that is partially expanded at the part wrapped with the heat insulation member 11 is formed. Accordingly, the contact pressure between the ice plug and the corresponding inner wall of the surrounded portion has increased, and thus the frictional force of the ice plug has increased, resulting in higher resistance to pressure as opposed to when the heat insulation member 11 is not wrapped (step 4). The ice plug formed has a higher resistance to pressure.

A drain pipe 51 is connected to the coolant vessel 14 and a drain valve 13 is installed on the drain pipe 51.

In the method for improving residual stress of a structure member, a method for giving compression residual stress to the inner surface of a pipe will be described with reference to FIG. 2, in which the ice plug according to the present embodiment, which is resistant to pressure within the pipe, is used to expand pipes near a welded portion and thereby to give compression residual stress.

FIG. 2 illustrates the method for giving compression residual stress to the inner surfaces of pipe 3 by forming ice plugs 5 resistant to pressure within the pipe 3 and then expanding the pipe 5 near the welded portion 1 due to freezing water between the formed ice plugs 5. The pipe 3 includes the welded portion 1.

External coolant vessels 7 for forming an ice plug are disposed around the upstream and downstream positions of pipe 3 of a welded portion 1 respectively. The welded portion 1 is positioned between the external coolant vessels 7. Heat insulation members 11 are wrapped around the entire outer periphery of the pipe 3 near the center portion in an axial direction of the pipe 3 in each of the external coolant vessels 7. External surfaces of the pipe 3 in each of the external coolant vessels 7 are cooled to form ice plugs 5, which is resistant to pressure within the pipe 3 at positions of each of the external coolant vessels 7. Two ice plugs 5 are formed in the pipe 3 at positions surrounded by each of the external coolant vessels 7 as shown in FIG. 1. The external surface of the pipe 3 is cooled between the ice plugs 5. The water between the ice plugs 5 in the pipe 3 is cooled and frozen. Prepared edges 2 of the pipe 3 near the welded portion 1 are expanded in a radial direction of the pipe 3 by volume expansion of the water at the time of freezing. Therefore, compression residual stress is given to the inner surface of the pipe 3. A strain gauge 12 disposed on an outer surface of the pipe 3 at the vicinity of the welded portion 1 measures a strain generated in the vicinity of the welded portion 1 by the expansion of the weld portion 1 and the like in the radial direction. Measured values of the strain are output from the strain gauge 12 to a strain measuring-instrument 33. The strain measuring-instrument 33 is calculated amount of the expansion in a peripheral direction of the pipe 3 at the vicinity of the welded portion 1. The amount of the expansion is displayed on a display device. An operator can know a degree of compression residual stress given to the inner surface of the vicinity of the welded portion 1 based on the amount of the expansion displayed by the display device.

The use of ice plugs resistant to pressure within the pipe improves resistance to pressure, so the size of the external coolant vessel 7 can be reduced. Accordingly, workability for giving compression residual stress to small-diameter pipes, which are often used in narrow, complex paths in a power generation plant, is substantially improved. According to the present embodiment, compression residual stress can be easily given to even the small-diameter pipe, thickness of which is thin.

### Second Embodiment

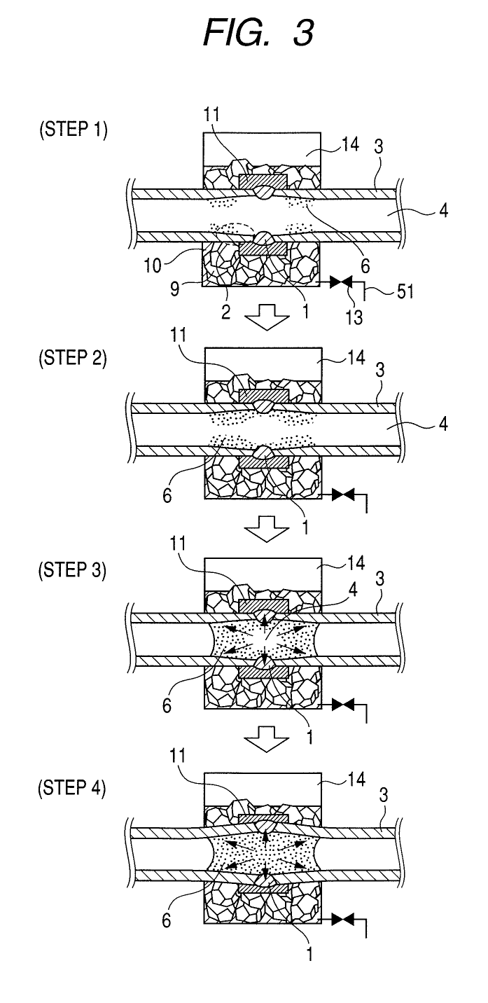

A method for improving residual stress of a structure member of a second embodiment, which is another embodiment of the present invention, will be described with reference to FIG. 3. The method for improving residual stress is a method for giving compression residual stress to inner surface near a welded portion, in which one coolant vessel is used. In this method, the entire outer peripheries of pipe and the welded portion positioned near the center portion in an axial direction of the pipe in the coolant vessel are covered with a heat insulation member and the pipes near the welded portion are expanded in the coolant vessel.

FIG. 3 illustrates the present embodiment concerning the method for giving compression residual stress to the inner surface of pipe near a welded portion by expanding the pipe near the welded portion using one coolant vessel.

A coolant vessel 14 is disposed around pipe 3 filled with water 4 so that a welded portion 1 of the pipe 3 is positioned at a center portion in the axial direction of the pipe 3 in the coolant vessel 14. The pipe 3 is a small-diameter pipe and thickness of the pipe 3 is thin. A heat insulation member 11 is then wrapped around the welded portion 1 and the entire outer peripheries of the pipe 3 near the center portion in the coolant vessel 14. The thickness and axial length of the heat insulation member 11 are adjusted so that strain generated at prepared edges 2, which are formed near the welded portion 1, in the peripheral direction is 0.4% or more depending on the outer diameter and thickness of the pipe 3. Ethanol 10 and dry ice 9 are then supplied into the coolant vessel 14 through an opening portion (not shown) formed at an upper end of the coolant vessel 14. In the surrounded portion, the water 4 in the pipe 3 is cooled, starting from the inner surfaces of the prepared edges 2 near the welded portion 1 around which the heat insulation member 11 is not wrapped and ice 6 then starts to be formed at these positions (step 1).

As time elapses, the ice 6 also forms at a part wrapped with the heat insulation member 11, in the surrounded portion. However, the cooling capacity varies depending on whether the heat insulation member 11 is wrapped. Therefore, the water in the surrounded portion near both ends of the coolant vessel 14 freeze faster than the part wrapped with the heat insulation member 11, thus producing a difference in the thickness of the ice 6 (step 2).

As time further elapses, parts near both ends of the coolant vessel 14, at which freezing occurs faster, in the surrounded portion, are blocked by the ice 6, and the water 4 is left in the part wrapped with the heat insulation member 11, of the surrounded portion. As the freezing proceeds, the internal pressure in that part rises (step 3).

When the water 4 left in the part wrapped with the heat insulation member 11 is completely frozen, ice 6 that is partially expanded at the part wrapped with the heat insulation member 11 is formed. Accordingly, the prepared edges 2 near the welded portion 1 are expanded, giving compression residual stress to the inner surface of the pipe 3 (step 4).

Although, in the conventional method, at least three coolant vessels have been required, the method in the present embodiment requires only one coolant vessel 14. Accordingly, the workability for giving compression residual stress to small-diameter pipes, which are often used in narrow, complex paths in a power generating plant, is substantially improved. According to the present embodiment, compression residual stress can be easily given to even the small-diameter pipe, thickness of which is thin.

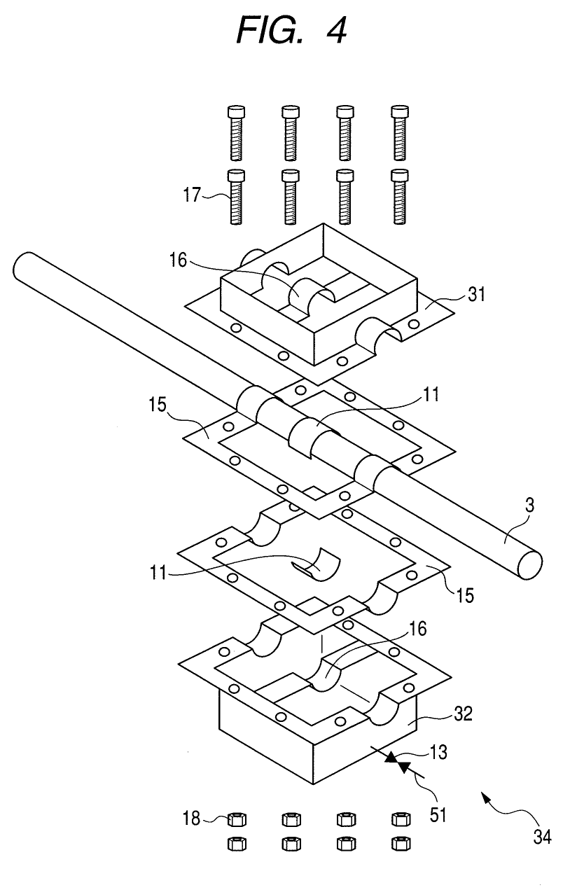

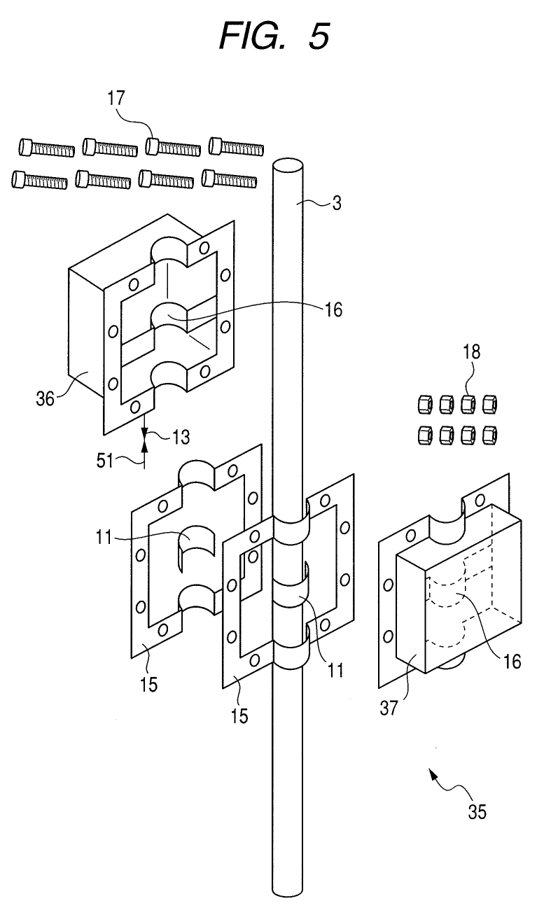

A coolant vessel in which a heat insulation member has been wrapped in advance near its center portion so as to form an ice plug resistant to pressure within the pipe will be described with reference to FIGS. 4 and 5.

FIG. 4 illustrates an embodiment of a coolant vessel disposed for a horizontal pipe in which a heat insulation member has been wrapped around the center portion in an axial direction of the pipe in the coolant vessel in advance. This coolant vessel is used as the coolant vessel 14 in the first and second embodiments.

A coolant vessel 34 for forming an ice plug resistant to pressure within a pipe 3 disposed horizontally, has an upper coolant vessel lid 31 and a lower coolant vessel lid 32. In the coolant vessel 34, the pipe 3 is clamped between the upper coolant vessel lid 31 and the lower coolant vessel lid 32 with packings 15 and heat insulation members 11 intervening therebetween. The upper coolant vessel lid 31 and lower coolant vessel lid 32 are fixed together by bolts 17 and nuts 18.

The upper coolant vessel lid 31 and lower coolant vessel lid 32 are each equipped with a support device 16 for attaching heat insulation member 11 at the center portion of the vessel. To fix the upper coolant vessel lid 31 and lower coolant vessel lid 32 together, it is also possible to hinge one side of the upper coolant vessel lid 31 and one side of the lower coolant vessel lid 32 and dispose a buckle to sides opposite of the hinge, in which case the coolant vessel is attached to the pipe 3 by fixing the buckle and detached by releasing the buckle.

FIG. 5 illustrates an embodiment of a coolant vessel disposed for a vertical pipe in which a heat insulation member has been wrapped around the center portion in the coolant vessel in advance. This coolant vessel is used as the coolant vessel 14 in the first and second embodiments.

A coolant vessel 35 for forming an ice plug resistant to pressure within a pipe 3 disposed vertically, has a side coolant vessel lid (with a drain valve) 36 and a side coolant vessel lid (without a drain valve) 37. In a coolant vessel 35, the pipe 3 is clamped between the side coolant vessel lid 36 and the side coolant vessel lid 37 with packings 15 and heat insulation member 11 intervening therebetween. The side coolant vessel lid 36 and side coolant vessel lid 37 are fixed together by bolts 17 and nuts 18. The side coolant vessel lid 36 and side coolant vessel lid 37 are each equipped with a support device 16 for attaching heat insulation member 11 at the center portion of the vessel. To fix the side coolant vessel lid 36 and side coolant vessel lid 37 together, it is also possible to hinge one side of the side coolant vessel lid 36 and one side of the side coolant vessel lid 37 and dispose a buckle to the sides opposite of the hinge, in which case the coolant vessel is attached to the pipe 3 by fixing the buckle and detached by releasing the buckle.

### Third Embodiment

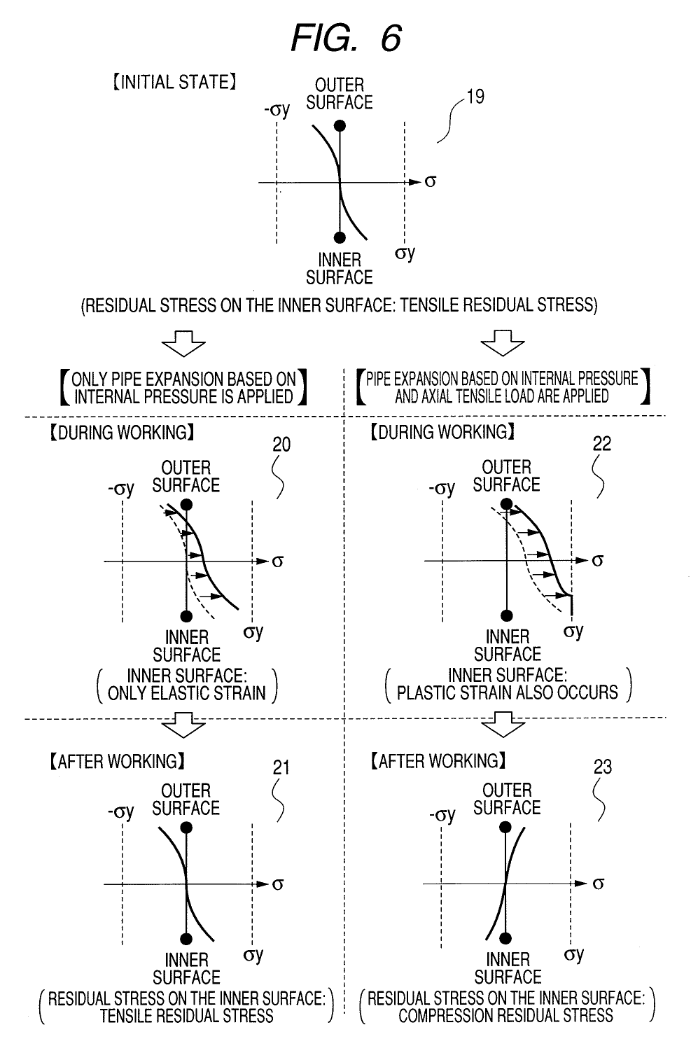

A method for improving residual stress of a structure member of a third embodiment, which is further another embodiment of the present invention, will be described with reference to FIGS. 6 to 8. Described below with reference to FIG. 6 is a method for giving compression residual stress to an inner surface of pipe by applying an axial tensile load and expanding the pipe near a welded portion.

FIG. 6 illustrates stress distributions when an axial tensile load is applied to pipes that are expanded near a welded portion within a range of elastic deformation.

In a residual stress distribution after welding near a welded portion of a pipe, that is, a residual stress distribution 19 before working, the residual stress on an inner surface of the pipe is tensile residual stress. This pipe is a small-diameter pipe. When the pipe is expanded within the range of elastic deformation, a stress distribution 20 during working (only internal pressure for the expansion of the pipe is applied) has no area where the yield stress σy is exceeded, so a stress distribution 21 after working (only internal pressure for the expansion of the pipe is applied) is the same as the residual stress distribution 19 before working.

By comparison, suppose that an axial tensile load is applied to a pipe, which is a small-diameter pipe, that has been expanded within the range of elastic deformation. In a stress distribution 22 during working (internal pressure for the expansion of the pipe and an axial tensile load are applied), the yield stress σy is exceeded on the inner surface of the pipe, so plastic distortion is caused. Therefore, in a residual stress distribution 23 after working (internal pressure for the expansion of the pipe and an axial tensile load are applied), the residual stress on the inner surface is the compression residual stress.

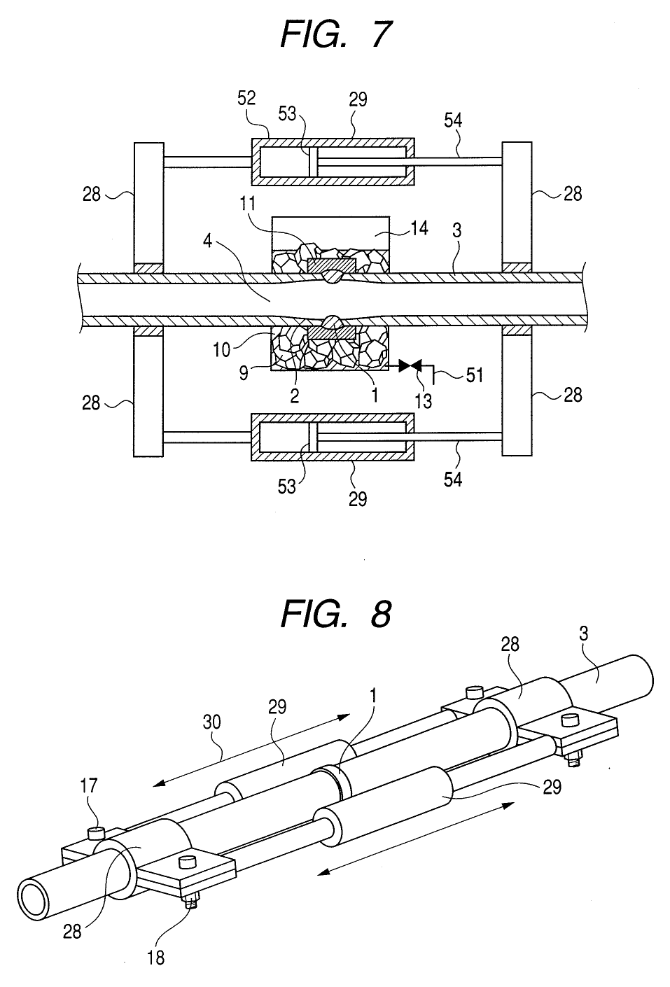

The method for improving residual stress of a structure member of the present embodiment shown in FIG. 6 will be described in detail below with reference to FIGS. 7 and 8.

In the present embodiment, the coolant vessel 14, and a tensile apparatus 52 for adding an axial tensile to the pipe 3 are used. The tensile apparatus 52 is provided with a pair of a fixing device 28, hydraulic cylinders 29, pistons 53 and piston rods 54. A pair of the hydraulic cylinders 29 is attached to the fixing device 28 and arranged in parallel each other. Each piston 53 is disposed in each hydraulic cylinder 29. Each piston rod 54 is connected with each piston 53 in each of the hydraulic cylinders 29 and attached to another fixing device 28.

A coolant vessel 14 is disposed around the pipe 3 filled with water 4 so that a welded portion 1 of the pipe 3 is positioned at a center portion in the axial direction of the pipe 3 in the coolant vessel 14 as with the second embodiment. The pipe 3 is a small-diameter pipe and thickness of the pipe 3 is thin. A heat insulation member 11 is also wrapped around the welded portion 1 and the entire outer peripheries of the pipe 3 near the center portion in the coolant vessel 14.

The tensile apparatus 52 is attached to the pipe 3. As shown in FIG. 8, the fixing devices 28 are attached to the pipe 3 at upstream and downstream positions of a welded portion 1. That is, the fixing device 28 clamps a pipe 3 from its outer surface and fixes the pipe 3 with bolts 17 and nuts 18. To apply a tensile load to the pipe 3, a hydraulic cylinder 29 operating under oil or water pressure, which is disposed between the two fixing devices 28, is extended in the axial direction of the pipe 3.

The water 4 in the surrounded portion is cooled and frozen by the coolant vessel 14 supplied ethanol 10 and dry ice 9 thereto during adding the axial tensile load to the pipe 3 by the tensile apparatus 52. Thus, the welded portion 1 and the vicinity of the welded portion 1 of the pipe 3 are expanded in the radial direction in a state of adding the axial tensile load to the pipe 3. The stress distribution 22 shown in FIG. 6 is generated in the pipe 3 at this time.

When the axial tensile load is removed from the pipe 3 and the ice in the pipe 3 thawed, the stress distribution 23 shown in FIG. 6 is generated in the pipe 3. That is, compression residual stress is given to the inner surface of the pipe 3 at the welded portion 1 and the vicinity of the welded portion 1.

When the method for improving residual stress of a structure member of the present embodiment is executed, the internal pressure for the expansion of the pipe and the addition of the axial tensile load must be applied at the same point in time, but the order of their application is not important.

According to the present embodiment, it can obtain an effect to increase the residual stress given on the inner surface of the pipe by the expansion of the welded portion 1 and the addition of axial tensile load to the pipe. Accordingly, when the method of the present embodiment is used on the welded portion of pipes with an outer diameter of 60 mm or more to 114.3 mm or less for which pipe expansion by only the internal pressure is insufficient to sufficiently improve the residual stress, the residual stress on the internal surface can also be improved in compression residual stress. According to the present embodiment, compression residual stress can be easily given to even the small-diameter pipe, thickness of which is thin.

When the method for improving residual stress of a structure member of the present embodiment is used to expand a welded part of an elbow, the effect of applying compression residual stress to the internal surface can be increased.

### Forth Embodiment

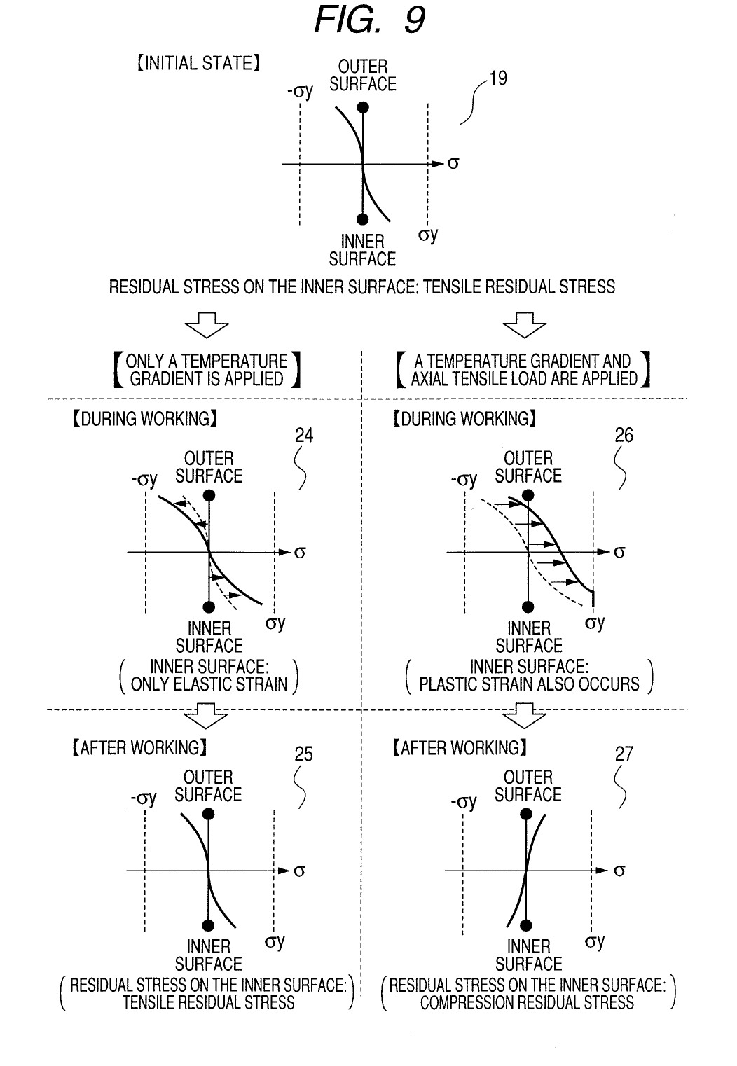

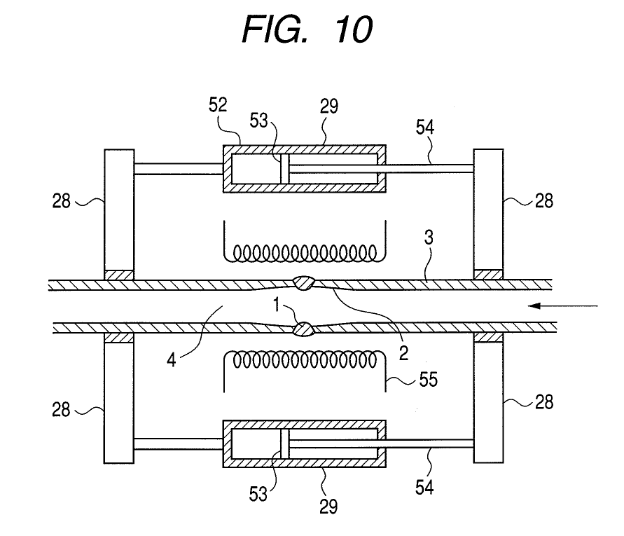

A method for improving residual stress of a structure member of a forth embodiment, which is further another embodiment of the present invention, will be described with reference to FIGS. 9 and 10.

Described below with reference to FIG. 9 is a method for giving compression residual stress to an inner surface of a pipe by adding an axial tensile load and creating a difference in temperature between an inner surface and outer surface of the pipes near a welded portion.

FIG. 9 illustrates stress distributions when a difference in temperature is created between an inner surface and outer surface of a pipe so that deformation due to thermal expansion occurs within a range of elastic deformation and then an axial tensile load is applied.

In a residual stress distribution near a welded portion of a pipe, that is, the residual stress distribution 19 before working, the residual stress on an inner surface of the pipe is the tensile residual stress. This pipe is a small-diameter pipe. When a difference in temperature is created so that deformation due to thermal expansion of the pipe occurs within the range of elastic deformation, a stress distribution 24 during working (only a temperature gradient is applied) has no area where yield stress σy is exceeded, so a stress distribution 25 after working (only a temperature gradient is applied) is the same as the residual stress distribution 19 before working.

By comparison, suppose that an axial tensile load is given to a pipe in which a difference in temperature is created so that deformation due to thermal expansion occurs within a range of elastic deformation. This pipe is a small-diameter pipe. In a stress distribution 26 during working (a temperature gradient and axial tensile load are given), the yield stress σy is exceeded on the inner surface of the pipe, so plastic distortion is caused. Thus, in a residual stress distribution 27 after working (a temperature gradient and axial tensile load are given), the residual stress on the inner surface is the compression residual stress.

The method for improving residual stress of a structure member of the present embodiment shown in FIG. 9 will be described in detail below with reference to FIG. 10.

In the present embodiment, the tensile apparatus 52 is attached to the pipe 3 as with the third embodiment. A heater 55 is installed around the welded portion 1 and the vicinity of the welded portion 1. A high-frequency heating apparatus can uses in stead of the heater 55.

The water is supplied into the pipe 3 by driving a pump (not shown) attached to the pump during adding the axial tensile load to the pipe 3. The outer surface of the welded portion 1 and the vicinity of the welded portion 1 of the pipe 3 are heated by the heater 55 in a state of supplying the water 4 to the pipe 3. Therefore, since the difference in temperature is created between the inner surfaces and outer surfaces of the welded portion 1 and the vicinity of the welded portion 1, the stress distribution 26 shown in FIG. 6 is generated in the pipe 3 at this time.

When the axial tensile load is removed from the pipe 3 and the supply of the water 4 and the heating are stopped, the stress distribution 27 shown in FIG. 9 is generated in the pipe 3. That is, the compression residual stress is given to the inner surface of the pipe 3 at the welded portion 1 and the vicinity of the welded portion 1.

When the method for improving residual stress of a structure member of the present embodiment is executed, the difference in temperature between the inner surface and outer surface and the axial tensile load must have been applied at the same point in time, but the order of their application is not important.

The method for improving residual stress of a structure member of the present embodiment is also effective for small-diameter pipes the thickness of which is too thin to apply a large difference in temperature between the inner surface and outer surface, deformation due to thermal expansion being small and falling within a range of elastic deformation. Accordingly, when an axial tensile load is applied to cause plastic distortion on the inner surface during giving the difference in temperature between the inner surface and outer surface, the compression residual stress can be given to even the inner surface of the small-diameter pipe after working.

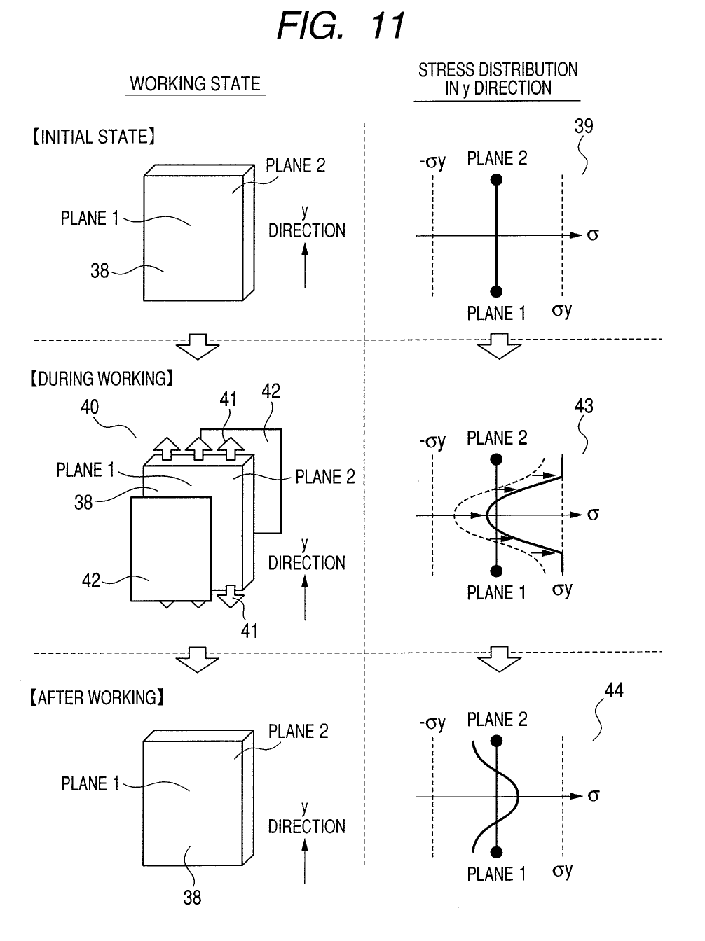

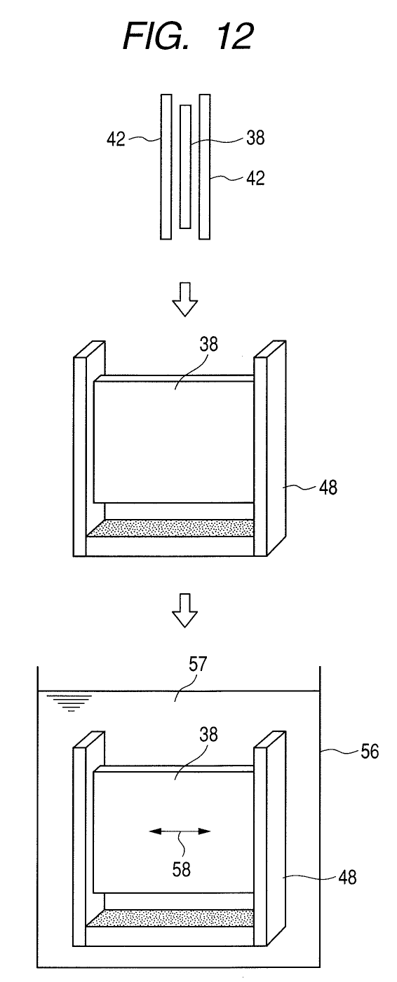

Described below with reference to FIGS. 11 and 12 is a method in which an external tensile or compression load is given in one direction in order to apply residual stress, and then distributed stress caused by a temperature distribution or deformation is given so that compression residual stress is selectively given in the direction in which the external load has been added.

### Fifth Embodiment

A method for improving residual stress of a structure member of a fifth embodiment, which is further another embodiment of the present invention, will be described with reference to FIGS. 11 and 12.

FIG. 11 illustrates a concept of the present embodiment in which a temperature distribution and an external load are given to a flat plane so that residual stress exerted on the surface of the flat plate in the direction in which the external load is applied is improved in compression residual stress.

In the present embodiment, a flat plate 38 is steeped in cooling water 40, after which an external tensile load 41 is given in a y direction and the flat plate 38 is heated with a high-frequency heater 42. Since the flat plate 38 generates heat and planes 1 and 2, which are brought into contact with the cooling water 40, are cooled, the temperature distribution of the flat plate 38 is such that a surface is at a low temperature and a center portion in a direction of thickness of the flat plate 38 is at a high temperature. This difference in temperature causes a difference in thermal expansion between the surface and the center portion. Therefore, a stress distribution 43 in the direction of the thickness of the flat plate 38 during working, includes a tensile stress distribution occurred on the outer surface and a compression stress distribution occurred in the center portion. When the flat plate 38 is thin and the stress distribution is as indicated by the dotted line, in which there is no region where the yield stress σy is exceeded, an effect of improving the residual stress cannot be expected. When, however, the external tensile load 41 in one direction (for example, the y direction) is superimposed, the yield stress σy is exceeded in a region near the outer surface. In a residual stress distribution 44 of the flat plate 38 after working, therefore, the residual stress is improved in compression residual stress in the region near the outer surface of the flat plate 38.

The method for improving residual stress of a structure member of the present embodiment in which the concept shown in FIG. 11 will be described with reference to FIG. 12 in detail below. FIG. 12 shows a process, which is illustrated in FIG. 11, during working for giving compression residual stress on the surface of the flat plate.

The flat plate 38 is heated by using the high-frequency heater 42 outside a tank filled with water 57. The heating of the flat plate 38 outside the water is easier than that of the flat plate 38 steeped in the water. Both ends of the flat plate 38, the temperature of which was risen by heating, is attached to a restraining device 48 after the flat plate 38 was heated. The flat plate 38 attached to the restraining device 48 is steeped in the water 57 filled in the tank 56 with the restraining device 48. The hot flat plate 38 is cooled in a state that the both ends thereof was restrained by the restraining device 48 so that tensile stress occurs in one direction, that is, a direction 58. Further, by cooling the flat plate 38, the temperature distribution of the flat plate 38 occurs such that the surface is at a low temperature and the center portion is at a high temperature by cooling the flat plate 38 in the tank 56. In result, since the tensile stress 49 in the direction 58 is superimposed to the stress distribution caused by a difference in temperature, in which tensile stress is exerted on the outer surface and compression stress is exerted on the inner surface, the stress distribution 43 shown by a solid line in FIG. 11 occurs in the thickness direction of the flat plate 38. Thus, the yield stress σy is exceeded in a region near the outer surface of the flat plate 38 and the residual stress distribution 44 after working is higher than when only the difference in temperature is used for working. The compression residual stress is given to the surface of the flat plate 38.

### Sixth Embodiment

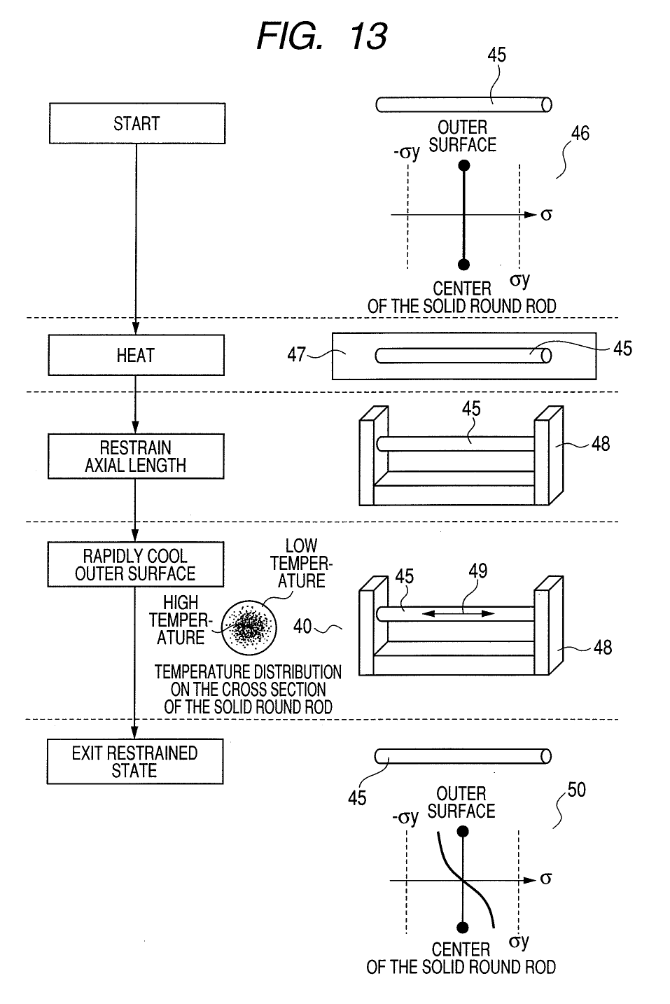

A method for improving residual stress of a structure member of a sixth embodiment, which is further another embodiment of the present invention, will be described with reference to FIG. 13. The present embodiment is an example for giving compression residual stress to a surface of a solid round rod.

FIG. 13 illustrates a concept of the present embodiment in which compression residual stress is applied to an surface of a solid round rod by heating the solid round rod to a high temperature and then steeping the solid round rod into cooling water with its axial length being restrained by a restraining device so as to give a temperature distribution to a center portion of the solid round rod and apply an external tensile load caused by the restraint of the axial length.

The solid round rod 45 has a residual stress distribution 46 in an initial state. First, the solid round rod 45 at room temperature is heated in a high temperature chamber 47 to a high temperature. The hot solid round rod 45 is attached to a restraining device 48 at room temperature, which restrains the axial length of the solid round rod 45, so that the axial length is kept constant. The hot solid round rod 45 attached to the restraining device 48 is steeped in cooling water 40, causing the solid round rod 45 to have a temperature distribution in which the surface of the solid round rod 45 is at a low temperature and the center portion of the solid round rod 45 is at a high temperature.

Furthermore, when the temperature is lowered, the solid round rod 45 contracts, so axial tensile stress occurs due to the restraint of the restraining device 48. Since tensile stress 49 applied by the restraint is superimposed to the stress distribution caused by a difference in temperature, in which tensile stress is exerted on the surface and compression stress is exerted in the center portion, a region where the yield stress σy is exceeded is expanded near the surface. A residual stress distribution 50 after working is thus higher than when only the difference in temperature is used for working.

The present invention can be applied to environments in which various materials that are likely to cause stress corrosion cracks are used. In particular, the present invention can be used to suppress stress corrosion cracks in welded structures made of nickel base alloys or austenitic stainless steel.

What is claimed is:

1. A method for improving residual stress of a structure member, comprising steps of:
disposing coolant vessels around a pipe being the structure member at an upstream position and a downstream position of a welded portion of the pipe;
wrapping a heat insulation member around an outer periphery of the pipe at a center portion in an axial direction of the pipe in each of the coolant vessels;
forming the ice plug in the pipe at each position disposing the coolant vessels by cooling an outer surface of the pipe wrapping the heat insulation member in the coolant vessels; and
freezing water between the ice plugs in the pipe by cooling the outer surface of the pipe between the ice plugs.

2. A method of improving residual stress of structure member, comprising steps of:
disposing a coolant vessel around a welded portion of a pipe being the structure member;
wrapping a heat insulation member around an outer periphery of the welded portion at a center portion in an axial direction of the pipe in the coolant vessel; and
forming ice in the pipe at a position surrounded by the coolant vessel by cooling the outer surface of the pipe in the coolant vessel.

3. A method for forming an ice plug within a pipe, comprising the steps of:
disposing a coolant vessel around a pipe filled with water;
wrapping a heat insulation member around an outer periphery of the pipe near a center portion in an axial direction of the pipe in the coolant vessel; and
cooling an outer surface of the pipe in the coolant vessel.

4. A coolant vessel for forming an ice plug in a pipe, wherein the coolant vessel includes a heat insulation member which surrounds the pipe at a center portion of the coolant vessel when the coolant vessel is disposed on the pipe.

5. A method for improving residual stress of structure member, comprising steps of:
adding tensile load to a welded portion of a pipe being the structure member in an axial direction of the pipe; and
expanding the pipe in a radial direction of the pipe at the welded portion and the vicinity of the welded portion by increasing internal pressure of the pipe.

6. A method for improving residual stress of structure member according to claim 5, wherein the step of expanding the pipe includes steps of disposing coolant vessels around a pipe being the structure member at an upstream position and a downstream position of a welded portion of the pipe; wrapping a heat insulation member around an outer periphery of the pipe at a center portion in an axial direction of the pipe in each of the coolant vessels; forming the ice plug in the pipe at each position disposing the coolant vessels by cooling an outer surface of the pipe wrapping the heat insulation member in the coolant vessels; and freezing water between the ice plugs in the pipe by cooling the outer surface of the pipe between the ice plugs.

7. A method for improving residual stress of structure member according to claim 5, wherein the step of expanding the pipe includes steps of disposing a coolant vessel around a welded portion of a pipe being the structure member; wrapping a heat insulation member around an outer periphery of the welded portion at a center portion in an axial direction of the pipe in the coolant vessel; and forming ice in the pipe at a position surrounded by the coolant vessel by cooling the outer surface of the pipe in the coolant vessel.

8. A method for improving residual stress of structure member, comprising steps of:
adding tensile load to a welded portion of a pipe being the structure member in an axial direction of the pipe;
heating an outer surfaces of the welded portion and a vicinity of the welded portion of the pipe; and
cooling the inner surfaces of the welded portion and the vicinity of the welded portion so as to produce a difference in temperature between the outer surfaces and the inner surfaces during adding the tensile load.

9. A method for adding tensile load, comprising steps of:
attaching two fixing devices to a pipe at upstream and downstream positions of a welded portion of the pipe; and
adding tensile load to the welded portion in an axial direction of the pipe through the two fixing devices.

10. A method for improving residual stress of structure member, comprising steps of:
adding a external load to the structure member in a direction in which to give residual stress, and
giving stress caused by a temperature distribution during adding the external load.
